(19) United States
(12) Patent Application Publication
(10) Pub. No.: US 2003/0051017 A1
(43) Pub. Date: Mar. 13, 2003

(54) Internet apparatus automatically generating internet address

(75) Inventors: Jun-Ho Choi, Seoul (KR); Cheon-Seong Lee, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD, Suwon-City (KR)

(21) Appl. No.: 10/228,990

(22) Filed: Aug. 28, 2002

(30) Foreign Application Priority Data
Aug. 28, 2001 (KR) 2001-52109

(51) Int. Cl. G06F 15/177; G06F 15/16

(52) U.S. Cl. 709/222; 709/245

(57) ABSTRACT

An Internet apparatus, such as an Internet digital video disc (DVD) and Internet television, automatically generating an Internet address. The Internet apparatus comprises a random address generator, an address combiner, and a network controller. The random address generator randomly generates a first address as part of an address to be used in the apparatus for Internet access. The address combiner has a second address commonly used in a same type of apparatus and combines the second address with the first address and generates the address. The network controller accesses the Internet using the generated address, thereby obviating using a fixed address in apparatus, and obviating an additional process of allocating an address during manufacture of the apparatus, improving productivity.

### CROSS-REFERENCE TO RELATED APPLICATIONS

This application claims the benefit of Korean Application No. 2001-52109 filed Aug. 28, 2001, in the Korean Industrial Property Office, the disclosure of which is incorporated herein by reference.

### BACKGROUND OF THE INVENTION

1. Field of the Invention

The present invention relates to an apparatus (appliance) that is able to connect to the Internet, such as an Internet digital video disc (DVD) and Internet television, and more particularly, to an Internet apparatus that automatically generates an Internet address for the Internet apparatus.

2. Description of the Related Art

Internet DVDs have LAN cards and web browsers that allow conventional DVDs to access the Internet. Typically, Internet DVDs have unique media access control (MAC) addresses (Internet addresses) to represent a data source and a destination when communicating via the Internet.

The MAC address used by a data link layer (in the OSI Model network layers) is comprised of 48-bit (6-byte) and is the same as an Ethernet address or a token ring address. Hardware addresses allocated to network cards by a network card manufacturer are universally administered addresses (UAAs), and all network cards have a unique value.

Like allocation of the hardware addresses to network cards, it is desirable that Internet apparatuses, such as Internet DVDs, have one unique MAC address. Therefore, in mass production, conventional Internet apparatuses are distributed after undergoing a process of setting a unique MAC address in the Internet apparatuses.

### SUMMARY OF THE INVENTION

An object of the present invention is to provide an apparatus that can connect to the Internet in which there is no need to preset a unique media access control (MAC) address in manufacturing because of automatic generation of a MAC address by the apparatus during operation.

Additional objects and advantages of the invention will be set forth in part in the description which follows and, in part, will be obvious from the description, or may be learned by practice of the invention.

Accordingly, the present invention may be achieved by providing an Internet apparatus comprising a random address generator, an address combiner, and a network controller. The random address generator randomly generates a first address as part of an Internet address to be used in the Internet apparatus for Internet access, such as the MAC. The address combiner has a second address commonly used in a same type of Internet apparatus or as otherwise designated and combines the second address with the first address and forms the Internet address. The network controller accesses the Internet using the automatically generated Internet address.

In an aspect of the invention, the network controller verifies whether the generated Internet address is already used on the Internet and acquires a new Internet address from the random address generator and the address combiner if the previously generated Internet address is already used on the Internet.

### BRIEF DESCRIPTION OF THE DRAWINGS

These and other objects and advantages of the present invention will become more apparent by the following description of the preferred embodiments with reference to the attached drawings in which:

FIG. 1 is a functional block diagram of a conventional Internet digital video disc (DVD); and

FIG. 2 is a functional block diagram of an Internet DVD, according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

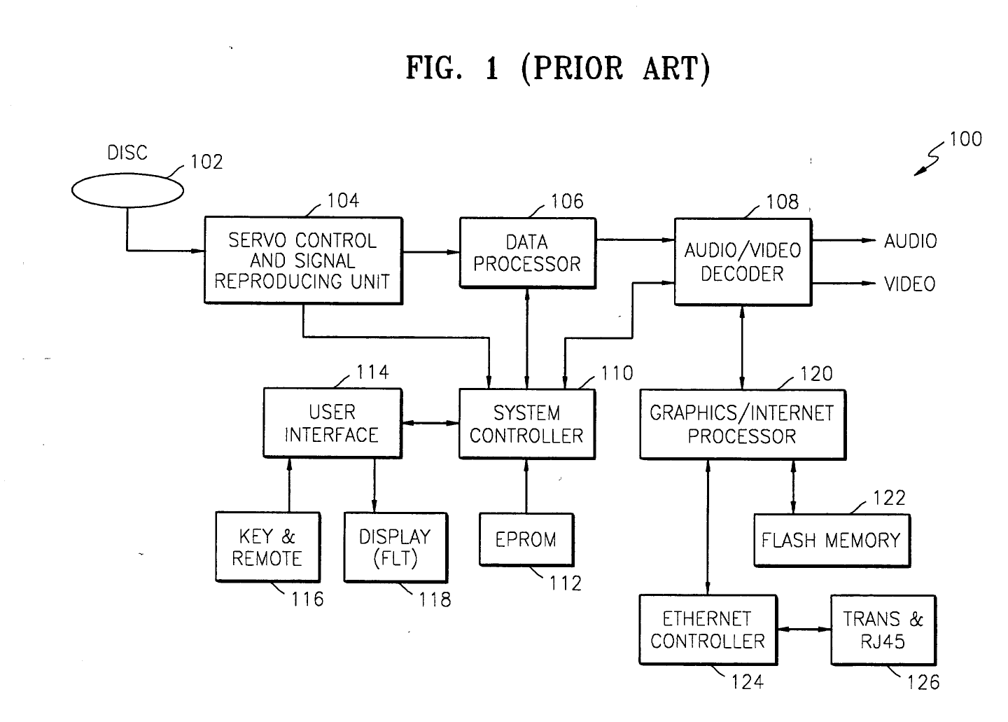

FIG. 1 is a functional block diagram of a conventional Internet digital video disc (DVD) 100. In the conventional Internet DVD 100, a servo control and signal regenerating unit 104 regenerates a signal recorded on a disc 102 and performs servo control operations, such as tracking, focusing, and tilting. A data processor 106 processes a regeneration signal output from the servo control and the signal regenerating unit 104 and the processor 106 decodes the processed regeneration signal into audio and/or video data. The audio/video decoder 108 regenerates audio and/or video signal from the audio/video data generated by the data processor 106 and outputs the audio and/or video signal. Typically, the audio and/or video signal is output to a speaker (not shown) and/or a display device, such as a cathode display panel (CDP, not shown).

In FIG. 1, a system controller 110 controls the servo control and signal regenerating unit 104, the data processor 106, and the audio/video decoder 108. A software program performing operations of the system controller 110 is stored in an EPROM 112.

Meanwhile, a user's command is applied to the system controller 110 via a key & remote input unit 116 and a user interface 114. A display FLT 118 receives and displays operation states of the apparatus 100 from the user interface 114.

The apparatus 100 accesses the Internet via an Ethernet controller 124 and a trans & RJ45 126, and a graphics/Internet processor 120 provides web browsing for Internet access (i.e., executes web browser software used to locate and display Internet web pages ). The web browsers are stored in a flash memory 122.

To allow the apparatus 100 access the Internet, a MAC address representing the apparatus 100 is required. Typically, the MAC address is is a 6-byte code. Three (3) bytes of the 6-byte code represent a vender, such as Samsung Electronics Co., Ltd. the assignee of the present application, etc. One (1) byte of the 6-byte code represents a product, and an other two (2) bytes of the 6-byte code represent a unique number assigned to the apparatus 100.

Thus, typically a unique MAC address used by each product is set via an additional process during manufacture of the apparatus 100.

However, setting a fixed unique Internet apparatus number, which is expressed as a 2-byte value in the MAC address, for each Internet apparatus, makes it close to impossible for a manufacturer to produce more than 2¹⁶ of the same product type Internet apparatuses. More specifically, there are allocated Internet apparatus numbers that are not actually used for reasons, such as sales (e.g., no sales), exhaust (discontinuations), and/or inability to connect to the Internet after an Internet apparatus has been distributed, and thus an address space allocated to an Internet apparatus cannot be used effectively. Also, a separate process of allocating a unique MAC address to the apparatus 100 is required in a manufacturing process.

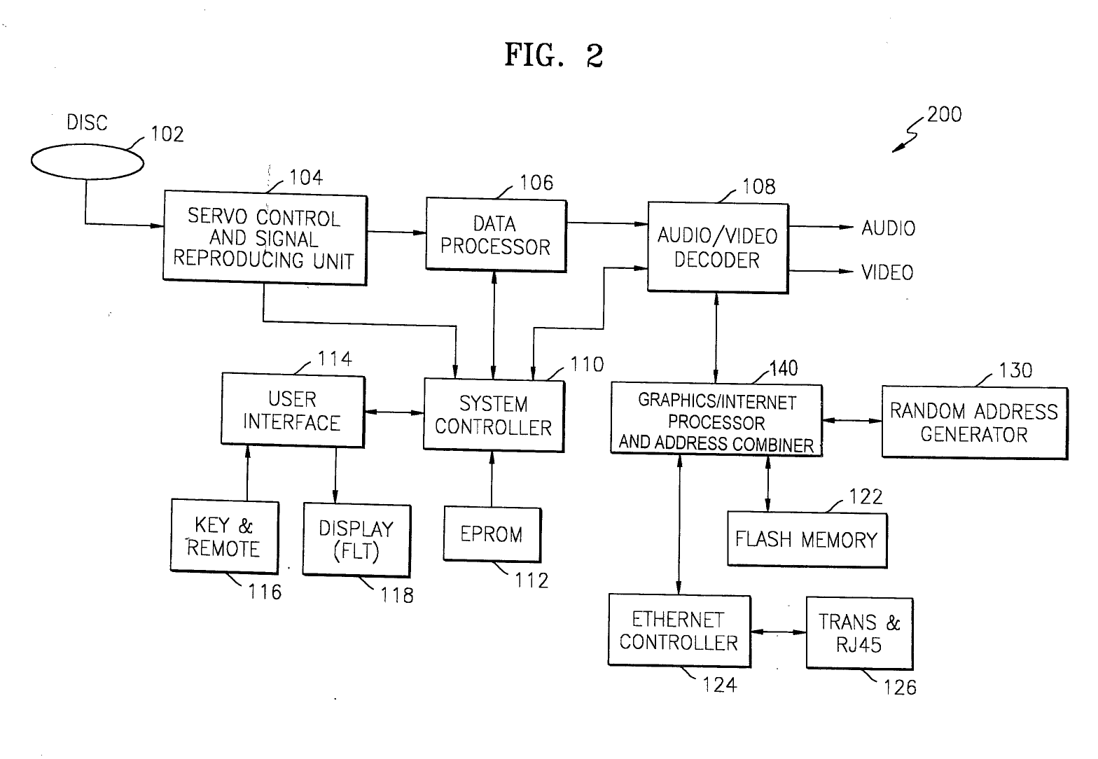

FIG. 2 is a functional block diagram of an Internet DVD according to an embodiment of the present invention. In the apparatus 200, the same reference numerals are used for the same elements as those shown in FIG. 1, and a detailed description thereof will be omitted.

The Internet apparatus 200 does not use a fixed MAC address but randomly generates a MAC address to be used whenever (i.e., each time) the apparatus 200 connects to the Internet. For this purpose, the apparatus 200 comprises a random address generator 130. The random address generator 130 randomly generates a first address of 2 bytes, which is part of the 6-byte code address typically used by the Internet DVD 200 whenever the Internet DVD 200 connects to the Internet or runs (operates).

The graphics/Internet processor and address combiner 140 provides a unique (personal) second address of 4 bytes of the 6-byte code, which is commonly used in the same type of products by representing a vender and certain type of a product. The address combiner 140 generates MAC addresses used by the apparatus 200 by combining the unique 4 byte second address with the first address generated by the random address generator 130. Typically, the second address is a fixed value having the same value in the same kind of products, and thus an additional process of setting the second address is not required.

Table 1 shows example media access control (MAC) addresses automatically generated according to an embodiment of the present invention.

TABLE 1

| | Vender (3-byte) | Serial (3-byte) |
|---|---|---|
| Samsung | 00-00-f0 | 21-80-E9 |
| Intel | 00-90-27 | 39-07-EA |
| DEC | aa-00-00 | 65-38-40 |

As shown in Table 1, MAC addresses can be classified into codes of 3-byte vender and 3-byte serial codes. Also, each 3-byte serial code is classified into a 1-byte product code and a 2-byte product serial number code. More specifically, a separate MAC address is allocated according to venders and venders' products.

In Table 1, the 3 byte vender code and the 1 byte product code correspond to the second 4-byte address, and the 2 byte product serial number code corresponds to the first address generated by the random address generator 130.

In FIG. 2, the Ethernet controller 124 (or a network controller of an Internet apparatus) receives the MAC address from the graphics/Internet processor 120, and thus accesses the Internet. The apparatus 200 can generate a new MAC address upon connecting to the Internet or upon operation, and thus there may be another Internet apparatus having the same MAC address on the Internet as the newly generated MAC address. For example, two Internet DVDs 200 having the same vender and model may generate the same first 2 byte addresses. To solve this problem, typically the apparatus 200 verifies whether an automatically generated MAC address is unique (i.e., is a personal MAC address).

Therefore, typically the Ethernet controller 124 verifies whether an automatically generated MAC address is already used on the Internet. If the generated MAC address is already used, the Ethernet controller 124 notifies the graphics/Internet processor 120 that the generated MAC address is already used. If the graphics/Internet processor 120 is notified by the Ethernet controller 124 that the generated MAC address is already used, the graphics/Internet processor 120 controls the random address generator 130 to generate a new first address, and combines the personal second address with the newly generated first address to generate another new MAC address, thereby providing the new MAC address to the Ethernet controller 124. The Ethernet controller 124 then accesses the Internet via the newly regenerated MAC address.

The Internet apparatus 200 automatically generates an address to be used in an address space of a MAC address whenever the apparatus 200 connects to the Internet or operates, thereby automatically generating MAC addresses and thus an address space allocated to a product in a MAC address can be used effectively. Further, the number of same model type Internet products that can be distributed is not limited by the address space allocated to the Internet product in the MAC address.

Further, a fixed MAC address is not used in each product, and thus there is no need in performing an additional process of allocating a MAC address in a manufacturing process, thereby improving productivity.

The random address generator 130 can be constituted by software and/or hardware. That is, typically a software program randomly generating a first address is stored in the flash memory 122, and the random address generator 130 runs the program when the Internet DVD 200 connects to the Internet or receives requests to generate first addresses. Although the example embodiment is an Internet DVD, the present invention is not limited to such Internet apparatus, and the present invention can be embodied in any Internet appliance, such as Internet TVs, etc., thereby obviating typical fixed (i.e., pre-determined at manufacture) MAC addresses. Further, although the example embodiment uses the MAC addressing standard as a data link layer addressing standard to access the Internet, the present invention is not limited to such configuration and the present invention can be used with any data link layer Internet addressing standard for connecting Internet apparatuses to the Internet. Further, although in the example embodiment MAC addresses as data link layer addresses are automatically generated to connect to the Internet, the present invention is not limited to such configuration and MAC addresses can be generated manually, for example, via the user interface 114. Further, although the example embodiment provides generating data link layer addresses, such as MAC addresses, in Internet appliances, such as Internet DVDs, TVs, etc., the present invention is not limited as such and the present invention can provide a data link layer address generator to be embodied in any appliance, computing device and/or components thereof, such as in a network controller (cards), that performs data communication based upon any data link layer network protocol (e.g., Ethernet, token-ring, or other known or to be developed data link layer protocols, etc.), thereby obviating use of pre-determined at manufacture data link layer addresses used in accessing networks.

The present invention provides an Internet apparatus that is able to connect to the Internet automatically or manually generating addresses to be used in an address space allocated to the apparatus whenever the apparatus connects to the Internet or operates, thereby automatically or manually generating Internet-apparatus MAC addresses and thus an address space, which is allocated to the Internet product, within the MAC address can be used effectively.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An Internet apparatus, comprising:
a random address generator randomly generating a first address as part of an address;
an address combiner, which has a second address commonly used in a same type of apparatus, combining the second address with the first address and generating the address; and
a network controller accessing the Internet using the address.

2. The apparatus of claim 1, wherein the network controller verifies whether the generated address is already used on the Internet and acquires a new address from the random address generator and the address combiner if the generated address is already used on the Internet.

3. The apparatus of claim 1, wherein the generated address is a media access control address.

4. An address generator embodied in an Internet appliance, the generator comprising:
a programmed computer processor automatically generating Internet addresses; and
a network controller receiving one of the Internet addresses, determining uniqueness of the one Internet address to access the Internet, and requesting another Internet address from the programmed computer processor in the event the one Internet address is not unique.

5. The address generator of claim 4, wherein the programmed computer processor randomly generates a first address as part of the Internet address and combines a second address, which is commonly used in Internet appliances of same type, with the first address to generate the Internet address.

6. The address generator of claim 5, wherein the Internet address is a media access control address comprising the first and second addresses and the first address is a 2-byte product serial number code and the second address is a 4-byte code comprising a 3-byte vender code and a 1-byte product code.

7. The address generator of claim 4, wherein the Internet appliance is one of an Internet DVD and an Internet TV.

8. The address generator of claim 6, wherein the Internet applicance is one of an Internet DVD and an Internet TV.

9. An Internet address generator embodied in an Internet appliance, the generator comprising:
a programmed computer processor automatically generating Internet addresses used by the Internet appliance to access the Internet, in response to the Internet appliance connecting to the Internet.

10. A data link layer address generator embodied in a computing device accessing a network, the generator comprising:
a programmed computer processor automatically generating data link layer addresses; and
a network controller receiving one of the generated data link layer addresses, determining uniqueness of the one generated address to access the network, and requesting another data link layer address from the programmed computer processor in the event the one generated address is not unique.

11. The generator of claim 10, wherein the programmed computer processor randomly generates a first address as part of the data link layer address and combines a second address, which is commonly used in the computing devices of same type, with the first address to generate the data link layer address.
